(19) United States
(12) Patent Application Publication
(10) Pub. No.: US 2002/0154766 A1
(43) Pub. Date: Oct. 24, 2002

(54) Automobile recorder

(76) Inventor: Oscar H. Campos, Boca Raton, FL (US)

Correspondence Address: MELVIN K. SILVERMAN, 4901 N. FEDERAL HWY., SUITE 410, FT. LAUDERDALE, FL, 33308, US

(21) Appl. No.: 09/838,346

(22) Filed: Apr. 20, 2001

(51) Int. Cl. H04M 1/00

(52) U.S. Cl. 379/454

(57) ABSTRACT

A system, including a vehicle dash panel, for use with at least one cell phone, includes a dash panel body having at least one elongate recess within a surface of the panel body, the recess having a primary axis positioned at a diagonal relative to a horizontal plane of the vehicle having the dash panel. The recess defines inner lateral surfaces which are proportioned for press-fittable receipt of at least forty percent of the mass of the cell phone. The recess includes a mouth and a distal base each substantially transverse to the inner lateral surfaces and the axis of the recess. The distal base is proportioned for complemental mechanical and electrical receipt of a charging end of the cell phone. Speaker/amplifier elements, in electrical communication with the audio inputs and outputs of the cell phone, are further provided. In a preferred embodiment, each of the mechanical aspects of the above, inclusive of a battery charger for cell phone, are positioned within the sound or audio module of the vehicle.

### BACKGROUND OF THE INVENTION

As is well known, the use of cell phones within automobiles and other vehicles has become a safety issue and, in some jurisdictions, is now prohibited. The need for “hands free” operation of a cell telephone within a vehicle, absent the use of a dedicated mobile telephone for each particular vehicle and a power base therefore, has been addressed only to a limited extent by the prior art. Such art, as is best known to the inventor, is reflected in U.S. Pat. No. 5,992,807 (1999) to Tarulli, entitled Universal Magnetic Stand For Cell Phones; and U.S. Pat. No. 6,135,408 (2000) to Richter, entitled Mobile Telephone Holder. These patents relate to so-called universal stands for cell phones and all entail modification to the dash panel (also known as dashboard) of the vehicle. As such, most car owners are reticent to make such a permanent modification to the interior of their vehicle. Further, Tarulli and Rechter above both entail the use of magnets, the long-term effect of which on the cell phone is unknown.

As such, there has existed a long felt need in the art for a means of “hands free” operation of a cell phone within a vehicle that does not require any permanent modification or alteration of the dash panel. In addition, other needs relative to cell phones and related devices, such as dictaphones, have not been met by existing interfaces and capabilities regarding vehicle dash panels. For example, a need may often arise in the course of speaking, while in a vehicle upon a cell phone, to record information which is occurring, or which has occurred, during a phone conversation. Given the added hazard associated with attempting to write or make notes upon a piece of paper while both driving and speaking upon a cell phone, a need has also developed for a recording capability of audio data during the course of a phone conversation or shortly thereafter. The within invention also address this need in the art.

Related needs also exist with regard to recordation. For example, one may often come upon a radio station broadcasting music or other information, which one wishes to record. Thereby, a recording capability relative to audio information from a cell phone can also serve other such needs of a driver.

Further, cell phone panel attachment means such a Tarulli and Rechter above, differentiate the cell phone holding function from the cell phone charging function when, in fact, as is taught by the within specification, integration of both needs into a single element of a car audio system may be readily accomplished. That is, the present invention avails itself of the fact that essentially all sound/audio modules employed with automobiles are constructed as a single stand-alone unit which is not installed into the vehicle until all other aspects of manufacture have been completed. See for example, U.S. Pat. No. 4,881,295 (1989) to Odemer, entitled Handle Assembly For Removable Auto Electronic Equipment. Thereby, a means of addressing the above set forth problems relative to mechanical securement, electrical charging and recordation of data are addressed as a part of the sound/audio module when it is manufactured remote from the site of production of the rest of the vehicle. This enables considerable design and application options, these as are more fully set forth below.

### SUMMARY OF THE INVENTION

The instant invention relates to a system, including a vehicle dash panel, for use with at least one cell phone. The system more particularly includes a dash panel body having at least one elongate recess within a surface of said panel body, said recess having a primary axis thereof positioned at a diagonal relative to a horizontal plane of the vehicle having said dash panel. Said recess defines inner lateral surfaces which are proportioned for press-fittable receipt of at least forty percent of the mass of said cell phone. Said recess further includes a mouth and a distal base each substantially transverse to said inner lateral surfaces and said axis of the recess. Said distal base is proportioned for complemental mechanical and electrical receipt of a charging end of said cell phone. Speaker/amplifier means, in electrical communication with the audio inputs and outputs of the cell phone, are further provided. In a preferred embodiment, each of the mechanical aspects of the above, inclusive of battery charging means for the cell phone, are positioned within the sound or audio module of the vehicle.

It is accordingly an object of the present invention to provide a vehicle-panel body within which a cell phone may be selectably press-fittably secured to effect “hands free” operation thereof.

It is another object to provide a system of the above type in which the audio inputs and outputs of the cell phone are in electrical communication with the audio speaker system of the vehicle.

It is another object of the invention to provide a system of the above type in which all mechanical and electrical capabilities of the system are integrated into the sound or audio module normally within the dash panel body of the vehicle itself.

It is a still further object to provide a system of the above type inclusive of means for selectable recording of conversation occurring during use of the cell phone, for the making of notes after or without reference to such phone call, and for the selectable recordation of material originating from the radio, an audio tape, or compact disk during otherwise normal use of the vehicle sound system.

It is a still further object of the invention to provide a system of the above type in which the cell phone securing means also includes means for selectable charging of the cell phone.

It is a still further object to provide a system of the above type useful in the securing within the vehicle dash panel of a dictaphone and the recharging of the batteries thereof.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

FIG. 1 is a perspective view of an auto-dash panel inclusive of an audio module which has been equipped with the instant invention.

FIG. 2 is a front plan schematic view showing the external appearance of an embodiment of the invention having capability for both a cell phone and dictaphone included within the vehicle audio module.

FIG. 3 is a vertical cross-sectional view taken through Line 3-3 of FIG. 2.

FIG. 4 is a front plan view showing an alternate embodiment of the audio module in which capability for securement of a single cell phone is provided.

### DETAILED DESCRIPTION OF THE INVENTION

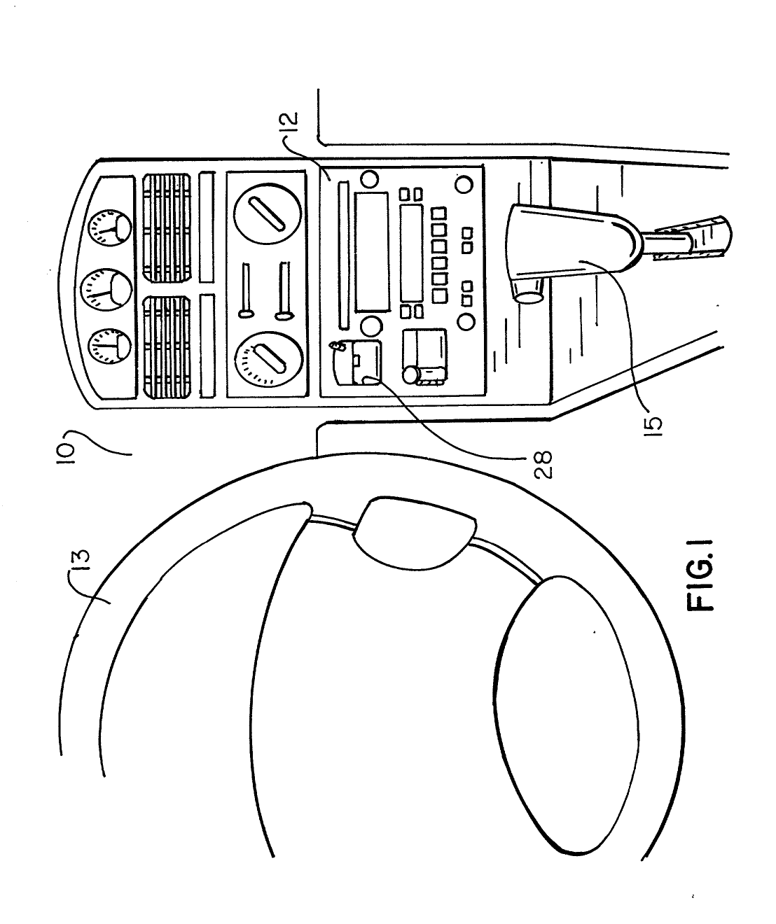

With reference to FIG. 1, there is shown in perspective view an automobile dash-panel 10 of a type which is generic to substantially all automotive vehicles such as cars, trucks, and SUVs. Such panels are also common in marine craft. Thereby, in essentially all such vehicles, a sound or audio module 12 is located to the right of a steering wheel 13 in that placement of the audio module too close to the steering wheel would interfere with the operator's use and movement of the steering wheel or gear shift 15, while placement of the module too far to the right would place the same beyond the reach of the driver. It is accordingly a given that essentially all sound/audio modules of land and marine vehicles are centrally located within the dash panel 10 of the vehicle. Further shown in FIG. 1 is the generalized appearance of the dash panel and audio module after a cell telephone, and/or dictaphone or recording means, has been incorporated thereinto, this as is more particularly set forth below.

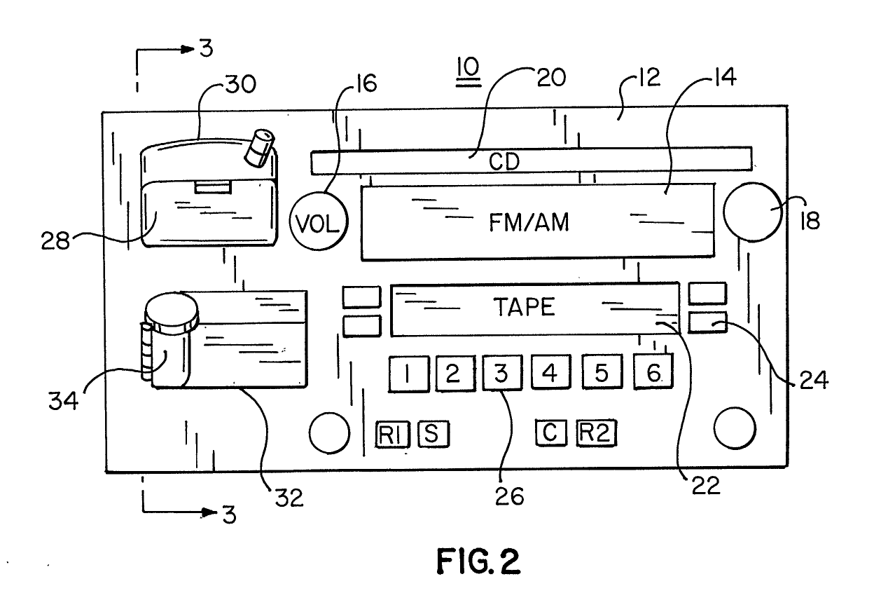

With reference to FIG. 2, the audio module 12 is shown in greater detail and, therein, are shown the standard features of every such audio module manufactured today, namely, a radio 14 having volume and tuning controls 16 and 18 respectively, a CD (compact disk) deck 20, an audio tape deck 22, various control buttons 24 therefor, and radio channel and band select means 26. All functions of the audio module are of course in electrical communication with a speaker system (not shown) which may assume any one of numerous configurations dependent upon the vehicle and budget of the owner thereof.

To the left of FIG. 2 is shown a cellular telephone (“cell phone”) 28 which has been placed into a diagonal recess 30, more fully described below. Further shown in FIG. 2 is the optional use of a second recess 32, (more fully described below), to place therein in a dictaphone or other recording means 34.

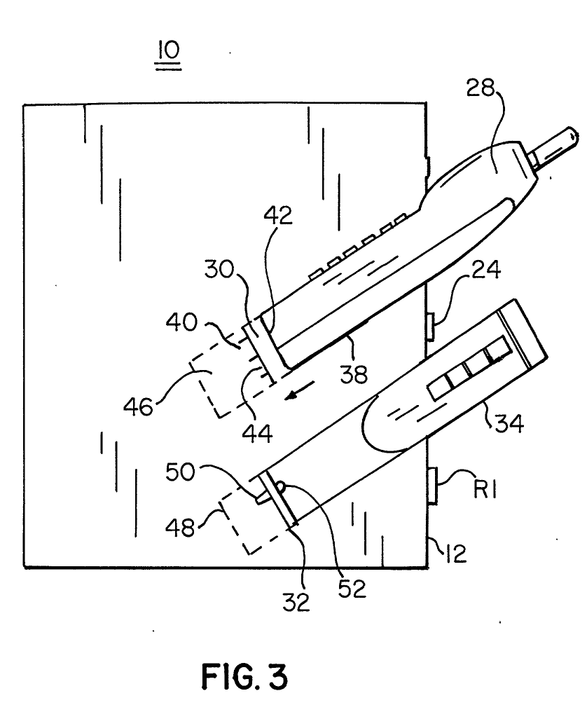

Said digital recesses 30 and 32 are more particularly shown in FIG. 3 (which is a transverse cross-sectional view of a panel-dash body 10 within which audio module 12 is supported. Therein may be seen said diagonal recesses 30 and 32 within which cell phone 28 and dictaphone/recording means 34 respectively may be placed. It has been determined that if the longitudinal axis of the recesses is at an ergonomically appropriate angle of about 30 degrees relative to the horizontal plane defined by the floor of the vehicle, at least forty percent of the mass of the cell phone 28 or recording means 34 must be disposed within the recess 30 and 32. As such, the combination of a slip fit, light frictional engagement with sidewalls 38 of the recesses, an angle of approximately 30 degrees, and the inclusion of at least forty percent of the mass of the cell phone or recording means within the respective recess will assure stability thereof relative to audio panel 12. Additional stability is assured through the provision of electrical charging contacts 40 within distal base 44 of the recess, and their mechanical interface with complemental charging contacts (not shown) at distal end 42 of the cell phone 28. As may be noted in FIG. 3, said charging contacts 40 are disposed within distal base 44 of said diagonal recess 30 and, as such, represent the only visible portion of electronics package 46 of the system which, in accordance with means well known within the state-of-the-art, provide charging capability to the cell phone, and electrical communication of the auto inputs and outputs of the phone through an amplifier (not shown), to the audio speaker system of the vehicle. Said electronic package thereby operates to increase the audio sensitivity of the cell phone such that “hands free” or speakerphone type operation is facilitated. The electronics and technology of speakerphones are well known in the art and, accordingly, is not set forth at length herein. Alternatively, increasing numbers of cell phones are today manufactured with “hands free,” also known as voice actuation, capability the significance thereof being that, in furtherance of the objects of the present invention, such a voice actuated speakerphone or amplification of said audio imputs and outputs cell phone 28 is essential in order to enable otherwise conventional telephone conversation to occur while cell phone 28 is secured within diagonal recess 30 of the audio module 12.

It is to be appreciated that an adapter may be provided at the interface between recess base 44 and cell phone base 42, if necessary, to compatibilize the voltages thereof.

Further shown in FIG. 3 is the optional dictaphone and recording mean capability which includes an electronic package 48 which, as with said electronic package 46, includes a charging pin 50 adapted for complemental communication with a charging port 52 of the recording means 34. Also, since the distance between the driver and the audio module may exceed the voice actuation capability of a typical dictaphone or recorder, electronic package 48 provides increased amplification of the normal voice actuation capability of conventional dictaphones.

Further shown in FIGS. 2 and 3 are the various control and mode capabilities of the present system, namely, control buttons R1, R2, S and C. The R1 button controls a record capability, in addition to that of recording means 34, wherein an audio tape may be placed within tape deck 22 for purposes of recording of audio material derived from the compact disk 20, radio 14, a micro cassette within recording means 34 when said means is in play mode, and for recording conversations in real time that are occurring between the driver and a called party through the use of cell phone 28, when said cell phone is secured within the recess 30. The last of these functions will, it is believed, prove quite valuable to business people and many others in that the use of a cell phone often entails the receipt of detailed information such as names, addresses, phone numbers, flight numbers and the like. Therefore, the present system, in addition to addressing the safety issues, associated with holding of a cell phone or dictaphone while driving, also substantially reduces a related problem, namely, that of persons making notes while driving regarding information that they have just received during the use of the cell phone.

The function of button R2 is applicable when a dictaphone or recording means is not present. That is, R2 operates to convert a tape within tape deck 22 into a voice memo pad such that notes or thoughts of a driver may be recorded onto such audiotape while he is driving, again without need to take one's hand off the steering wheel for such purpose.

The function of button S is to actuate the handsfree of speakerphone function of the system. In that it is anticipated virtually all future cell phones will be equipped with hands free operation, the S or speaker function of the system will be particularly applicable to older cell phones and to cell phones not equipped with hands free voice actuation having sufficient associated volume for the driver to conduct a normal conversation with all parties. Also, the S button will be of particular value to hearing impaired persons who require additional volume from their cell phones.

The C button of the system actuates the battery charge function associated with electronic packages 46 and 48 described above. The inclusion of the C button in the system is necessary to preclude overcharging of the cell phone or recording means.

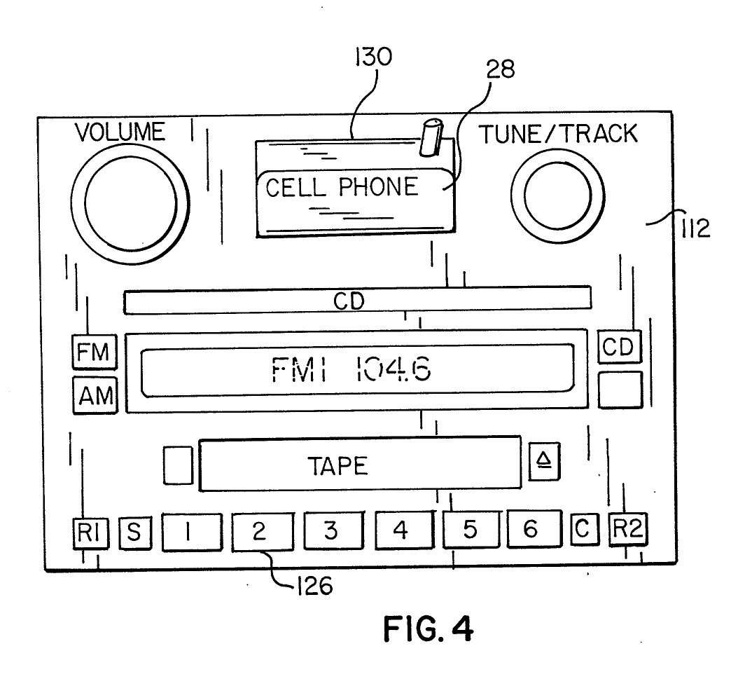

In FIG. 4 is shown an alternate embodiment of the present system in which the audio module 112 is provided with a single diagonal recess 130 within which cell phone 28 may be inserted. This it is believed will prove to be the most popular form of the present invention in that it is primarily business people who will require the additional recess 32 of FIGS. 2-3 for recording means or an additional recess for insertion of a second cell phone within the audio module. Other features of the audio module 112 are similar to those shown in the embodiment of FIG. 2, however, some of the functions, particularly, the C and R2 functions have been re-positioned. Therein, the R1 function, namely, the record function and the S function, namely, the speaker phone function, are disposed to the left of radio channel/band selection buttons 126, while the C and R2 buttons are disposed to the right thereof. It is to be appreciated that numerous other configurations of the various control and input elements of audio module 12 or 112 may be effected by those of skill in the art.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

Having thus described my invention what I claim as new, useful and non-obvious and, accordingly, secure by Letters Patent of the United States is:

1. A system including a vehicle dash-panel for use with at least one cell phone, said system comprising:
a dash panel body itself comprising:
(a) at least one elongate recess within a surface of said dash panel body, said recess having a primary axis thereof positioned at a diagonal relative to a horizontal plane defined by a vehicle having said dash panel;
(b) said recess defining inner lateral surfaces proportioned for press-fittable receipt of at least forty percent of the mass of said cell phone;
(c) said recess including a mouth and a distal base, each transverse to said inner lateral surfaces and said primary recess axis;
(d) said base of said recess proportioned for complemental mechanical and electrical receipt of a charging base of said cell phone; and
(e) within said base, means for charging said cell phone and for providing electrical communication with an audio module of the vehicle.

2. The system as recited in claim 1 further comprising:
(f) speaker means situated within a passenger compartment of said vehicle, said speaker means, inclusive of amplifier means, in electrical communication with audio inputs and outputs of said cell phone.

3. The system as recited in claim 2, said system further comprising:
means for charging a battery of said cell phone positioned within said dash panel body and in electrical communication with said distal base of said recess thereof.

4. The system as recited in claim 3 in which said dash panel body comprises:
a modular vehicle audiotape, compact disk and radio assembly within which said elongate recess, inclusive of said lateral and base surfaces, is positioned.

5. The system as recited in claim 3, in which said system further comprises:
means for selectably recording conversation from said speaker means.

6. The system as recited in claim 3, further comprising:
means for selectably recording of audiotape, compact disk or radio originated material.

7. The system as recited in claim 3, further comprising:
means for selectably actuating and de-actuating said charging means.

8. The system as recited in claim 3, further comprising:
means for selectably recording driver and/or passenger originated audio memoranda.

9. The system as recited in claim 2, further comprising:
cell phone voice actuation means.

10. The system as recited in claim 3 further comprising:
at least one diagonal recess within a surface of said dash panel body defining inner lateral surface proportioned for press-fittable receipt of at least forty percent of the mass of a dictaphone or recording means complemental to said recess.

11. The system as recited in claim 10, in which said recess further includes:
a distal base proportioned for mechanical and electrical receipt of a charging means of said dictaphone.

12. The system as recited in claims 11 further comprising:
speaker means situated within a passenger compartment of said vehicle, said speaker means, inclusive of amplifier means, in electrical communication with audio inputs and outputs of said recording means.

13. The system as recited in claim 11, said system further comprising:
means for charging batteries of said recording means positioned within said dash panel body and in electrical communication with said distal base of said recess thereof.
